(19) United States
(12) Patent Application Publication
(10) Pub. No.: US 2005/0031961 A1
(43) Pub. Date: Feb. 10, 2005

(54) Electrode plate for battery, nonaqueous electrolyte battery, and process for producing thereof

(76) Inventors: Masayuki Tsunekawa, Tokyo (JP); Yuichi Miyazaki, Tokyo (JP); Shin Miyanowaki, Tokyo (JP)

Correspondence Address: WILDMAN, HARROLD, ALLEN & DIXON, 225 WEST WACKER DRIVE, CHICAGO, IL, 60606, US

(21) Appl. No.: 10/749,180

(22) Filed: Dec. 30, 2003

(30) Foreign Application Priority Data
Jan. 8, 2003 (JP) 2003-002196

(51) Int. Cl. H01M 4/64; H01M 4/04

(52) U.S. Cl. 429/233; 141/1.1; 29/623.2; 29/623.5

(57) ABSTRACT

The present invention provides an electrode plate for a battery which prevents an electrode active material layer from being chipped and a collector from being broken on a course of production process and can be produced with large yield, processes for producing thereof, and a nonaqueous electrolyte battery using the electrode plate. A first electrode active material layer is formed intermittently on one surface of a sheet-like collector made of metal, and an electrode active material layer is formed intermittently on the other surface of the collector, wherein a starting position of the coating section is set so as to have a positional relationship in which it is 0.5 to 2.9 mm off from a starting side of the coated section of the first electrode active material layer on the one surface and shifted to a finishing side thereof.

### BACKGROUND OF THE INVENTION

1. Field of the Invention

The present invention relates to an electrode plate for a nonaqueous electrolyte battery. Particularly, it relates to an electrode plate for a battery which avoids breaking of an electrode plate in pressing step of its production process, a nonaqueous electrolyte battery, and processes for producing thereof.

2. Description of the Related Art

In recent years, the technology of audio-video equipments, personal computers or the like has advanced to be cordless and portable, and this advance has required reduction in size and weight as well as higher energy density to batteries used as driving power sources of these equipments. For these demands, there have been proposed nonaqueous electrolyte batteries having high energy density and high voltage, typically, a lithium ion secondary battery, in place of conventional alkaline batteries. Generally, a nonaqueous electrolyte battery is structured by the steps of: furnishing each of positive and negative electrode plates with a terminal to pass an electric current out from each electrode plate; winding up the electrode plates vorticosely together with a separator disposed between the electrode plates in order to prevent short-circuit between the electrode plates; inserting the electrode plates with the separator into a battery case filled with a nonaqueous electrolyte through its opening; and sealing the opening to form a sealed opening.

Feature size of a nonaqueous electrolyte battery is desired to become thinner and smaller due to the trend of equipments as becoming thinner and smaller and for the purpose of efficient use of space. In terms of performance, it is desired to elongate life span of a charge/discharge cycle and to realize higher energy density. To meet these demands, an electrode plate for a battery before winding is pressed to form a thin layer. If the electrode plate is made of a collector having electrode active material layers formed intermittently on both surfaces, due to the pressure generated by the press-working, the electrode active material layers are likely to be peeled and chipped, and the collector is easily broken depending on a positional relationship of the electrode active material layers on both surfaces of the collector. Particularly, a raised portion is created at a starting side in the coating process of the electrode active material layer. If a position of said raised portion coincides with a position of a starting or a finishing sides in the coating process of an electrode active material layer formed on the other surface, bending stress and tension are generated at boundary between said raised portion and its surrounding area. Thus, the collector receives stress which leads to hardening of the collector, and as a result, the collector is broken.

Therefore, a process for producing an electrode plate for a battery having thin layer thickness by pressing and high density is desired in which an electrode active material layer is not likely to chip and fracture during production process, it is large in yield, and production is capable at law cost.

Conventionally, following method is known to avoid breaking during pressing: that is, a collector which is a centripetal portion for power collection in a sheet-like form is unidirectionally conveyed; one surface (a first surface) of the collector is coated and dried to form a first electrode active material portion; and the collector is once wound up by a winder. Then, the wound collector is setup at an unwinder; the collector is conveyed in reverse direction; the other surface (a second surface) is coated intermittently and dried to form a second electrode active material portion. Upon forming the electrode active material portion on the second surface, it is known to have a positional relationship in which a starting side of the coating section of the electrode active material portion on the second surface is off from a finishing side of a coating section of the electrode active material portion of the first surface and shifted to a starting side thereof (For instance, Japanese Patent Application Laid-open (JP-A) No. 11-265707 and JP-A No. 2002-134102). However, by this method, in order to coat both sides of a collector, the coating process has to be halted. Hence, this method requires a coating process twice. Moreover, as shown in FIG. 5, each surface differs in running direction of coating process one another and thereby a starting side and a finishing side face each other, and a starting side and a starting side cannot be faced with a collector disposed between the coating sections. Thus, it is a defect of this method that a total number of boundaries (peaks) of raised portions existing at both surfaces of the collector is twice as many as that existing at one surface of the same size in area. Thereby, it is more likely that number of breakable portions doubles or chipping of an electrode active material layer is caused.

Additionally, JP-A No. 2001-15103, JP-A No. 2001-351610 and JP-A No. 2002-124249 also discloses prior arts of an electrode plate.

### SUMMARY OF THE INVENTION

In view of the above-mentioned problems, an object of the present invention is to provide an electrode plate for a battery in which an electrode active material layer is not likely to be damaged (peeling, chipping, cracking or the like, but especially chipping), a collector is not likely to be broken during production process, it is large in yield, and production is capable at law cost, a nonaqueous electrolyte battery using such an electrode plate, and processes for producing thereof.

In order to achieve the above object, an electrode plate for a battery of the present invention is comprised of a collector in a sheet-like form, an electrode active material layer (a first electrode active material layer) intermittently formed on one surface of the collector, and an electrode active material layer (a second electrode active material layer) intermittently formed on the other surface of the collector so as to have a positional relationship in which a starting side of the coated section of the second electrode active material layer is 0.5 to 2.9 mm off from a starting side of the coated section of the first electrode active material layer and shifted to a finishing side thereof.

A production process for an electrode plate for a battery of the present invention comprises steps of:
a) providing a collector in a sheet-like form;
b) providing an electrode active material layer coating composition;
c) forming a first electrode active material layer by applying an electrode active material layer coating composition intermittently to one surface of the collector by means of a coating means which is capable of consecutively subjecting the first surface and the second surface of the collector to intermittent coating process;
d) consecutively after the step “c”, forming a second electrode active material layer by applying the electrode active material layer coating composition intermittently to the other surface of the collector by means of the coating means described above, wherein a running direction of the coating process for the other surface is directed toward the same direction as the coating process for one surface of the collector, and wherein a starting position of the coating section is set so as to have a positional relationship in which it is 0.5 to 2.9 mm off from a starting side of the coated section of the first electrode active material layer and shifted to a finishing side thereof; and
e) pressing the collector in which electrode active material layers are formed on both sides.

A nonaqueous electrolyte battery of the present invention is designed so that an electrode plate-couple in which the positive electrode plate which is formed with a positive electrode active material layer having arrangement of an electrode plate for a battery according to claim 1 and the negative electrode plate which is formed with a negative electrode active material layer having arrangement of an electrode plate for a battery according to claim 1 are wound up together with a separator disposed between the electrode plates, and a solution of electrolyte in organic solvent are sealed in a container having a sealed opening capable of, before sealing, inserting the electrode plate-couple and the solution of electrolyte therethrough.

A production process for a nonaqueous electrolyte battery of the present invention comprises steps of:
inserting the electrode plate-couple, in which a positive electrode plate which is formed with a positive electrode active material layer having arrangement of an electrode plate for a battery produced by a method according to claim 2 and a negative electrode plate which is formed with a negative electrode active material layer having arrangement of an electrode plate for a battery produced by a method according to claim 2 is wound up together with a separator disposed between the electrode plates, and a solution of electrolyte in organic solvent into a container through its opening; and
sealing the opening to form a sealed opening.

Hereunder, the translation of the claims attached to the specification of the present invention is preliminary appended.

1. An electrode plate for a battery, comprising a collector in a sheet-like form, a first electrode active material layer intermittently formed on one surface of the collector, and a second electrode active material layer intermittently formed on the other surface of the collector so as to have a positional relationship in which an edge of a starting side of (an edge at an upper stream side in coating process of) each intermittently coated section of the second electrode active material layer is 0.5 to 2.9 mm off from a closest edge of a starting side of (a closest edge at an upper stream side in coating process of) each intermittently coated section of the first electrode active material layer and shifted to a finishing side (a lower stream side in coating process) thereof.

2. A production process for an electrode plate for a battery comprising steps of:
a) providing a collector in a sheet-like form, one surface thereof being referred as a first surface, and the other surface thereof being referred as a second surface;
b) providing an electrode active material layer coating composition;
c) forming a first electrode active material layer by applying an electrode active material layer coating composition intermittently to the first surface of the collector by means of a coating means which is capable of consecutively subjecting the first surface and the second surface of the collector to intermittent coating process;
d) consecutively after the step “c”, forming a second electrode active material layer by applying the electrode active material layer coating composition intermittently to the second surface of the collector, wherein a running direction of the coating process for the second surface is directed toward the same direction as the coating process for the first surface of the collector, and wherein a starting position of each intermittently coating section for the second electrode active material layer (an edge at an upper stream side in each intermittently coating section for the second electrode active material layer) is set so as to have a positional relationship in which it is 0.5 to 2.9 mm off from a closest edge of a starting side of (a closest edge at an upper stream side in coating process of) each intermittently coated section of the first electrode active material layer and shifted to a finishing side (a lower stream side in coating process) thereof; and
e) pressing the collector in which electrode active material layers are formed on both sides.

3. A nonaqueous electrolyte battery comprising a positive electrode plate formed with a positive electrode active material layer having arrangement of an electrode plate for a battery according to claim 1 and a negative electrode plate formed with a negative electrode active material layer having arrangement of an electrode plate for a battery according to claim 1, wherein an electrode plate-couple in which the positive electrode plate and the negative electrode plate are wound up together with a separator disposed between the electrode plates, and a solution of electrolyte in organic solvent are sealed in a container having a sealed opening capable of, before sealing, inserting the electrode plate-couple and the solution of electrolyte therethrough.

4. A production process for a nonaqueous electrolyte battery comprising steps of:
forming an electrode plate-couple by winding up a positive electrode plate and a negative electrode plate together with a separator disposed between the electrode plates, wherein the positive electrode plate is formed with a positive electrode active material layer having arrangement of an electrode plate for a battery produced by a method according to claim 2 and the negative electrode plate is formed with a negative electrode active material layer having arrangement of an electrode plate for a battery produced by a method according to claim 2;
inserting the electrode plate-couple and a solution of electrolyte in organic solvent into a container through its opening; and
sealing the opening to form a sealed opening.

### BRIEF DESCRIPTION OF THE DRAWINGS

In the accompanying drawings:

FIG. 1 is a cross-sectional view of an electrode plate for a battery before pressing showing an example of the present invention;

FIG. 2 is a cross-sectional view of an electrode plate for a battery before pressing showing other example of the present invention;

FIG. 3 is an explanatory view explaining a process for production showing an example of the present invention;

FIG. 4 is a cross-sectional view showing a positional relationship of an electrode active material layer 13 and an electrode active material layer 23; and

FIG. 5 is a cross-sectional view showing a conventional electrode plate for a battery before pressing.

Additionally, symbols in the figures respectively represent the following meaning:

| | |
|---|---|
| 1 | electrode |
| 1A, 1B | running direction of coating process |
| 11 | collector |
| 13, 23 | electrode active material layer |
| 13A, 23A | starting side |
| 13B, 23B | intermediate part |
| 13C, 23C | finishing side |
| 31 | unwinder part |
| 33A, 33B | die head |
| 35A, 35B | dryer |
| 37 | winder part |

### DETAILED DESCRIPTION OF THE PREFERRED EMBODIMENT

Hereinafter, with reference to figures, the embodiment of the present invention will be explained in more detail.

Basic Structure

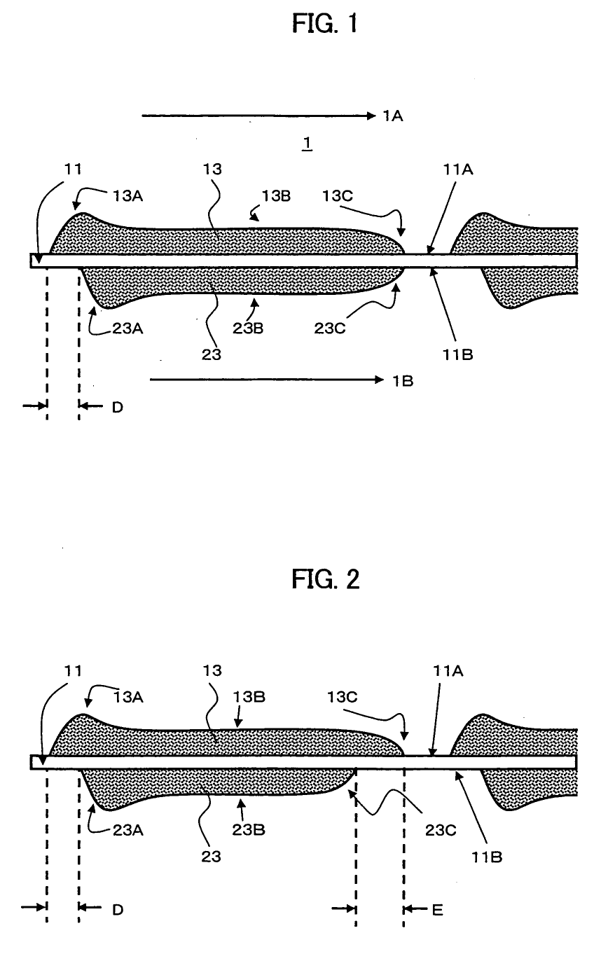

As shown schematically in FIG. 1, an electrode plate for a battery 1 of the present invention has a collector 11 wherein a first electrode active material layer 13 is formed on one surface (fist surface) 11A and a second electrode active material layer 23 is formed intermittently on another surface (second surface) 11B. The electrode active material layer 13 is coated in running direction of coating process 1A, and comprised of starting side 13A, intermediate part 13B and finishing side 13C. The electrode active material layer 23 on the second surface is coated and formed in the running direction of coating process 1B, which is the same direction as the running direction of coating process of the electrode active material layer 13 on the first surface, and comprised of starting side 23A, intermediate part 23B and finishing side 23C.

On each of the starting side 13A and 23A, relatively large raised portion is formed since the pressure inside of die head is high at the start of coating. The intermediate part 13B and 23B are coated to certain thickness under certain condition. The finishing side 13C and 23C are formed by a coating composition gradually reducing the thickness to create finishing side.

The starting side means the position where coating starts when an electrode active material layer is formed by coating. The finishing side means the position where coating ends when an electrode active material layer is formed by coating. In such a case that an electrode active material layer is formed intermittently by intermittent coating, a position where coating starts and a position where coating ends of individual sea-island shaped section are respectively a starting side and a finishing side.

Important Feature of the INVENTION

In the present invention, the electrode active material layer 23 is intermittently formed on the second surface 11B of the collector 11 by setting a positional relationship of the starting position (namely, starting side 23A) of the coated section so as to be 0.5 to 2.9 mm off from the starting side 13A of the coated section of the electrode active material layer 13 on the first surface 11A and shifted to the finishing side 13C. It is important that defining a distance of difference between the starting side 13A of the first electrode active material layer 13 and the starting side 23A of the second electrode active material layer 23 (namely, a distance of difference between front and rear surfaces) as D, D is in range of 0.5 mm≦D≦2.9 mm and that a position of the starting side 13A on the front surface and a position of the starting side 23A on the rear surface are set within the range not totally stand off from each other.

Specifically, a protuberance of the starting side on the front surface of the collector and a protuberance of the starting side on the rear surface of the collector are set to have the positional relationship in which they does not fully conform and neither do they totally separate each other while they are opposite to each other with the collector interposing between them. If peaks of those protuberances fully conform each other, they will lead to create one large hill. If peaks of those protuberances totally separate each other, it will create two separate hills. A possible minimum distance of difference between front and rear surfaces without having high peak is 0.5 mm. On the other hand, a maximum distance of difference between front and rear surfaces in which two hills across the front and the rear do not practically stand off is 2.9 mm.

“Two hills across the front and the rear do-not practically stand off” means that the total thickness of protuberances of the front surface and the rear surface which are intentionally set to have a slightly shifted positional relationship can be considered as one unit of increased thickness, which is a terrain from the edge of the starting side 13A of the front surface to the end of the starting side 23A of the rear surface without causing any extreme change in thickness of the electrode plate in the stage after the electrode active material layers are coated but before pressing. It also means that not only a typical terrace shape but also gentle ridge-like and wave-like corrugations are included in the scope of the present invention as far as the thickness of protuberance is deconcentrated.

In a case that a collector interposes between two electrode active material layers, wherein one surface has an electrode active material layer with a large protuberance on a certain place which causes big difference in thickness, and the other surface has an electrode active material layer with a lower protuberance or flatness, at the moment that such a large protuberance is carried through between two press rolls, an exceeding tension is generated in the vicinity of a surface of the collector having thinner electrode active material layer or at the thinner electrode active material layer on the collector. By said tension, there is the possibility that the electrode plate having the layered structure comprised in the order of the electrode active material layer/the collector/the electrode active material layer is damaged in such a manner that the collector is extended and broken, or the electrode active material layer is cracked, chipped and dropped due to shift or shear of stress generating in a hard electrode active material layer. If an electrode active material layer is chipped, battery capacity decreases. If the chipped material adheres to a press or guide roll of a pressing device, defective products are produced as follow-on electrode plates pass through the pressing device, and they will be damaged by a mark of the chipped material (concave) or a scar or by immigration of the chipped material. Once chipping is caused, as the operation is continuous pressing, a lot of defective products are serially produced to decrease yielding significantly. If a distance of difference between the front and the rear surfaces is less than 0.5 mm so that the protuberances of the front and rear surfaces are almost in the same location, it is likely to cause breaking. If said distance is 3.0 mm or more so that the location of the protuberances of the front and the rear surfaces are totally separated, it is likely to cause chipping. If a collector is made of a soft material, these problems are especially significant. For example, a negative electrode plate made of copper foil often has the above mentioned problems. In comparison with the starting sides 13A and 23A, finishing sides 13C and 23C of an electrode active material layer has relatively low risk of causing above mentioned problems as protuberance is not likely to be formed thereon.

According to the present invention, damages in an electrode active material layer and breaking of a collector during pressing process can be prevented, therefore, an electrode plate for a battery can be produced at low cost and large in yield. Batteries produced by using said electrode plate is not likely to decrease battery capacity and is high in reliability.

It is preferable to set a peak of a starting side 23A of a second electrode active material layer 23 in a position corresponding to an inclined portion in the range from a peak of starting side 13A to an intermediate portion 13B of a first electrode active material layer (see FIG. 1).

In an example shown in FIG. 1, a finishing side 13C of a first electrode active material layer 13 and a finishing side 23C of a second electrode active material layer 23 are in same location. The finishing side 23C of the second electrode active material layer 23 may be set in a position where it is shorter than the finishing side 13C of the first electrode active material layer 13 as shown in FIG. 2.

Process for Production

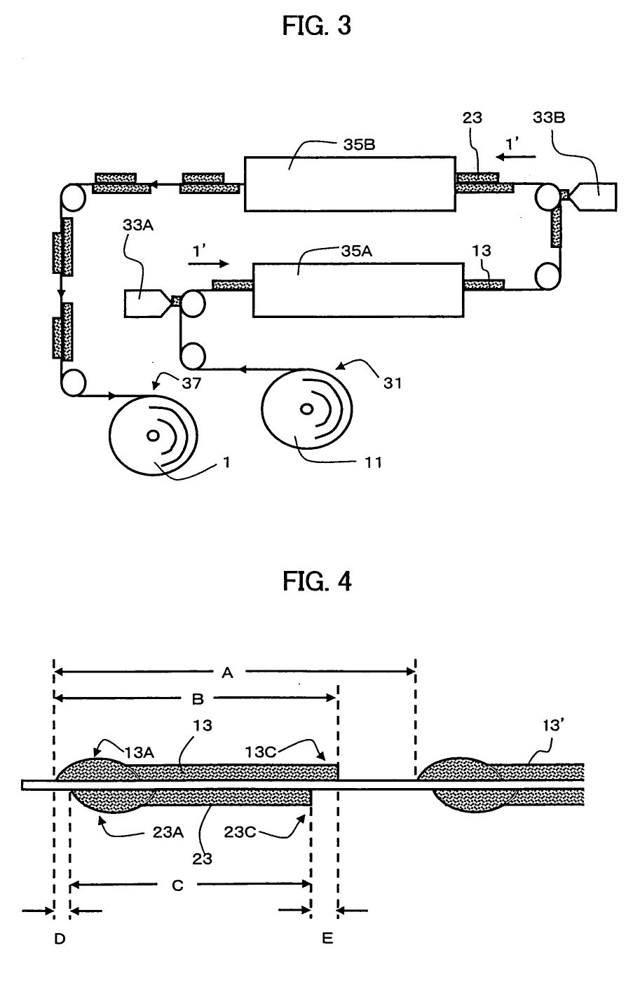

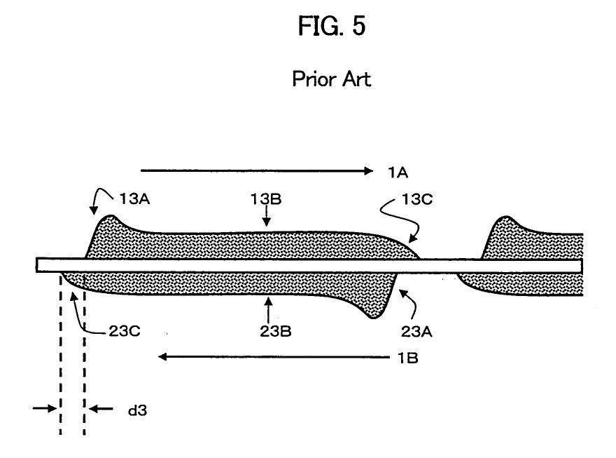

FIG. 3 shows an example of process for production of the present invention.

A production process for an electrode plate for a battery of the present invention comprises steps of: a) providing a collector in a sheet-like form; b) providing an electrode active material layer coating composition; c) forming a first electrode active material layer by applying an electrode active material layer coating composition intermittently to one surface of the collector by means of a coating means which is capable of consecutively subjecting one surface and the other surface of the collector to intermittent coating process; d) consecutively after the step “c”, forming a second electrode active material layer by applying the electrode active material layer coating composition intermittently to the other surface of the collector by means of the coating means described above, wherein a running direction of the coating process for the other surface is directed toward the same direction as the coating process for one surface of the collector, and wherein a starting position of the coating section is set so as to have a positional relationship in which it is 0.5 to 2.9 mm off from a starting side of the coated section of the first electrode active material layer and shifted to a finishing side thereof; and, e) pressing the collector in which electrode active material layers are formed on both sides.

Hereinafter, details will be further explained as well as explanation of the materials used therein.

a) Step of Providing a Collector in a Sheet-Like Form

The collector as a substrate of an electrode plate, a metallic sheet is generally used, for instance, a conventionally known metal foil. As the positive electrode plate, aluminum, nickel or the like may be used, and as the negative electrode plate, copper, nickel, stainless or the like may be used. Preferably, aluminum foil may be used for the positive electrode plate and copper foil may be used for the negative electrode plate. These metal foils have usually a thickness of about 5 to 30 μm, preferably 5 to 20 μm, which is provided in a rolled state of a long continuous sheet (hereinafter referred as roll).

b) Step of Providing an Electrode Active Material Layer Coating Composition

Electrode Active Material Layer

The active material layer contains at least an active material and a binder. The active material includes an active material for a positive electrode and an active material for a negative electrode. As the active material for a positive electrode, there may be used, for example, oxides of lithium transition metal complex such as LiCoO₂, LiNiO₂, LiMn₂O₄ or the like, or chalcogen compounds such as TiS₂, MnO₂, MoO₃, V₂O₅ or the like. These active materials for a positive electrode may be used alone or in combination of more than two kinds thereof. As the active material for a negative electrode, it is preferred to use, for example, metal containing lithium such as metallic lithium, lithium alloy or the like, or carbonaceous material such as graphite, carbon black or acetylene black.

Binder

As the binder, there may be used, for example, a thermoplastic resin, and more specifically, polyester resin, polyamide resin, polyacrylic acid ester resin, polycarbonate resin, polyurethane resin, cellulose resin, polyolefin resin, polyvinyl resin, fluorine resin or polyimide resin. Preferably, the binder is made of cellulose resin such as carboxymethyl cellulose, rubber base resin such as styrene-butadiene rubber, and fluorine resin. The fluorine resin is preferably used as the binder and the polyvinyliden fluoride is particularly preferred thereamong. If required, other resins or additives may be added.

Electrode Active Material Layer Coating Composition

The electrode active material layer coating composition is prepared by mixing the above mentioned active material, the binder and other compositions as occasion demands. For example, the active material or the like, which is appropriately selected, and the binder are mixed with an organic solvent such as toluene, methyl ethyl ketone, N-methyl-2-pyrrolidone, water or the mixture thereof, and a conductive agent is added therein as occasion demands to prepare a mixture. Thus prepared mixture is then dissolved or dispersed by means of a dispersing apparatus such as a planetary mixer, a homogenizer, a ball mill, a sand mill, a roll mill or the like thereby to prepare and provide the coating composition.

Step of c) and d), Namely Coating on Both Surfaces

In order to form the electrode active material layer on both surfaces of the collector, first, one surface (first surface) 11A of the collector 11 is subjected to intermittent coating and drying. Then the other surface (second surface) 11B is subjected to intermittent coating and drying while directing a running direction of the coating process toward the same direction as the coating process for the first surface 11A of the collector as well as setting a starting position (the starting side 23A) so as to have a positional relationship in which it is 0.5 to 2.9 mm (0.5≦D≦2.9 mm) off from a starting side 13A of an electrode active material layer 13 on the first surface 11A and shifted to a finishing side thereof.

It is preferable to conduct coating on the first surface and the second surface consecutively without stopping. The thickness of the electrode active material layers 13 and 23 in dried state is generally in the range of 10 to 200 μm, preferably 50 to 170 μm. A difference “D” between the front and the rear surfaces and a distance between the electrode active material layers 13 and 23 will be explained in detail later in Example.

The coating process for positive and negative electrodes is basically same only that a collector and an electrode active material layer coating composition are different.

Coating Means

First, as coating means, for example, a coating device is applicable which can continuously coat both surfaces of the collector without changing conveying direction (running direction of the coating process) as shown schematically in FIG. 3. The roll of the collector 11 is mounted on an unwinder part 31, the roll is released up by a drive mechanism, which is not shown in the drawing, and the collector 11 is carried to the conveying direction 1′. The electrode active material layer coating composition is coated intermittently on a first surface 11A of the collector 11 in a coating direction 1A (see FIG. 1), which is reverse to the conveying direction 1′, by a die head 33A, and then dried while passing through a dryer 35A to form an electrode active material layer 13.

Next, the electrode active material layer coating composition is coated intermittently on a second surface 11B of the collector 11 in a coating direction 1B (see FIG. 1), which is reverse to the conveying direction 1′, by a die head 33B, and then dried while passing through a dryer 35B to form an electrode active material layer 23. Thereafter, the collector 11 is wound up at a winder part 37. As for the die head 33B, the dryer 35B, the method for intermittent coating, they may be as same as coating of the first surface 11A.

As the die head, a die head which can form a thick coating layer is suitable, for example, slot die coat, slit die coat, slide die coat or the like.

The dryer may not be limited. Conventionally known hot wind, infrared rays, microwaves, high-frequency waves, or a combination thereof can be used. The drying may be performed by heat which is radiated by heating a metal roll or a metal sheet for supporting or pressing the collector in the drying process. The unwinder part 31 and winder part 37 may be those which are conventionally known.

Method for Intermittent Coating

In order to form a first electrode active material layer on the first surface intermittently in a predetermined pattern form, the electrode coating composition is coated on the collector while mechanically controlling the die head, so that a pattern comprised of a coated portion and a non-coated portion is directly formed. Specifically, discharging of the electrode active material layer coating composition from the die head may be repetitiously started and stopped while moving the die head and/or collector according to the pattern of the coated portion or non-coated portion, or withdrawal and re-approach of the die head may be repeated while synchronizing them with stop and re-start of discharging the electrode active material layer coating composition respectively.

As a method to set a starting positions of coating sections so as to have a positional relationship in which it is an appropriate distance off from a starting side 13A toward a finishing side of the electrode active material layer 13 on the first surface 11A, or to set an appropriate coating length upon forming the second electrode active material layer on the second surface intermittently in a predetermined pattern form, there may be a method using conventionally known sensor and control device, which can easily set so that a movement of the die head and/or collector is synchronized with withdrawal and re-approach of the die head and/or start and stop of discharging the electrode active material layer coating composition from the die head.

e) Step of Pressing the Collector in which Electrode Active Material layers are formed on both sides.

Press-Working

The obtained electrode active material layer is subjected to the press-working. Said press-working enables the electrode plate to become higher in density and to increase the maximum length of the electrode plate to be wound up in a battery. This means that it enables to increase the amount of the electrode active material, hence it is possible to make the battery higher in capacity. Both positive and negative electrode plates, which have large influence on the performance of secondary buttery, are respectively subject to press-working so that it extends life span of a charge/discharge cycle and energy density becomes higher. The press-working is performed using, for example, a metal roll, an elastic roll, a heating roll, a sheet-press machine, or the like.

Taking the thickness of the electrode plate after pressing into account, pressing may be carried out in several times or in multistage.

Generally, pressing may be carried out for plural times or once with high pressure to obtain an electrode active material layer having a predetermined thickness. However, the electrode plate receives large load, thus the collector having electrode active material layers formed intermittently on both surfaces may cause peeling or chipping of the electrode active material layer or easy breaking of the collector itself depending on the positional relationship of the electrode active material layers on both surfaces.

Particularly, a starting side of the electrode active material layer creates a protuberance. If a position of said protuberance coincides with a position of a starting side or a finishing side on the other surface, quite large amount of bending stress and tension are generated at boundary between said protuberance and its surrounding area. Thus, the collector receives stress and hardening is induced due to the working, which leads breaking of the collector. Further, besides pressing, the breaking and bending of the electrode plate occur upon cutting and winding process.

Such problems can be avoided by the means of the present invention that the running direction of coating processes of the front and the rear surfaces are set to be same, and a distance of difference “D” between the starting side 13A of the front surface and the starting side 23A of rear surface is set to be in range of 0.5≦D≦2.9 mm. As for the finishing side, a position of the finishing side 13C and the finishing side 23C may coincide with each other, or a position of the finishing side 23C on the rear surface may be set to be apart from the finishing side 13C toward upper stream side (see FIG. 2). After pressing, the electrode plate for a battery of the present invention may be slightly crushed because the protuberance is pressed.

Therefore, an electrode plate for a battery having thin layer thickness by pressing, high density and high accuracy can be produced, and it is possible to avoid chipping of the electrode active material layer and breaking of the collector as well as enabling large yield and law cost on a course of the production process. Further, the performance of a battery using said electrode plate for a battery does not deteriorate.

Slit and Cutting

After the press-working, cutting is carried out to make the electrode plate with predetermined width and length, or in the case of a coin-like form, with a predetermined shape. The shape of electrode plate is narrow and long. For example, a positive electrode material of a lithium-ion battery for a mobile phone has a narrow side width of about 20 to 70 mm and a long side length of about 0.2 to 1 m. In the case of a coin battery, a narrow side width is about 1 to 100 mm and a long side length is about 50 to 1000 mm. For this purpose, the aforementioned process for producing an electrode plate may be a case of processing a wide roll which has width and length to extent capable of taking out plural products.

Assembling a Battery

Thereafter, a process may be carried out in such manner that: a terminal to pass an electric current is fixed on each of a positive electrode plate and a negative electrode plate produced by the aforementioned method; the both electrode plates together with a separator disposed between them to prevent short-circuit are wound up vorticosely, and inserted through an opening of a container, which is filled with a nonaqueous electrolyte; and the opening is then sealed. As a nonaqueous electrolyte, for instance in the case of a lithium secondary battery, there may be used a nonaqueous electrolyte wherein lithium salt as a solute is solved in organic solvent. As lithium salt, there may be used inorganic lithium salt such as LiClO₄, LiBF₄ or the like, organic lithium salt such as LiB(C₆H₅)₄, LiN(SO₂CF₃)₂, LiC(SO₂CF₃)₃ or the like.

In the present invention, damages in an electrode active material layer and breaking of a collector can be prevented in the pressing process, therefore, an electrode plate for a battery having thin layer thickness by pressing, high density and high accuracy can be provided.

The process for producing an electrode plate for a battery of the present invention can prevent the electrode active material layer from being damaged as well as the collector from being broken on a course of production process, and can produce an electrode plate of good quality with large yield and law cost.

Further, a nonaqueous electrolyte battery of the present invention is not likely to deteriorate performance of a battery since the electrode active material layer of the electrode plate mounted in the battery is not likely to be damaged and high in reliability.

Further, the process for producing the nonaqueous electrolyte battery of the present invention provides the nonaqueous electrolyte battery which is little in risk of deteriorating a performance of battery, since the electrode active material layer is not likely to be damaged and high in reliability.

### EXAMPLE

### Example 1

Positive Electrode

Difference Between Front and Rear: D=1 mm

One surface of an aluminum foil having thickness of 15 μm was subjected to coating and drying process, and the other surface thereof was consecutively subjected to coating and drying process using the following positive electrode active material coating composition by means of the unwinder, the winder and an in-line double-face coating device equipped with two pairs of a die head and a dryer shown in FIG. 3. The coating amount per one surface was 250 g/m² after dried.

FIG. 4 is a cross-sectional view which shows positional relationship between electrode active material layers 13 and 23 of an electrode plate produced in Example 1. As shown in FIG. 4, “B” stands for a coating length of the electrode active material layer 13 on one surface, “A” stands for a pitch distance to the following electrode active material layer 13′, “C” stands for a coating length of the electrode active material layer 23 on the other surface, “D” stands for a distance of difference between a starting side on a front surface and that on a rear surface, and “E” stands for a distance of difference between a finishing side on a front surface and that on a rear surface.

In the Example 1, the positional relationship for coating was set as: A=700 mm; B=650 mm; C=599 mm; D=1 mm; and E=50 mm.

After coating, the electrode plate was pressed by means of a roll press machine so that the density of the electrode active material layer was to be 3.7 g/cm³, thereby, a positive electrode plate of Example 1 was obtained. The “D” after pressing was D=0.5 mm, however, significant difference was not found in “E”.

The positive electrode active material coating composition was prepared in a manner of mixing and kneading 92 parts by weight of CELLSEED C-10 (trade name for lithium cobaltate powder available from Nippon Chemical Industrial Co., Ltd.), 1.5 parts by weight of DENKA BLACK (trade name for acetylene black available from Denkikagaku Kogyo Co., Ltd), 1.5 parts by weight of TIMCAL-KS-15 (trade name for graphite available from TIMCAL Ltd.), and 41.7 parts by weight (it is equivalent to 7 parts by weight in solid content) of KFL #1120 (trade name for 12% polyvinyliden fluoride in N-methylpyrrolidone solution available from Kureha Chemical Industry Co., Ltd.) by means of a planetary mixer, adding N-methylpyrrolidone for adjusting viscosity, and then dispersing it.

### Examples 2-3 and Comparative Examples 1-2

Positive Electrode

Difference “D” Between Front and Rear: Changing

Except that the positional relationship for coating was set as values shown in Table 1, a positive electrode plate was obtained in the same manner as Example 1.

TABLE 1

| | | Example | Example | Example | Comparative | Comparative |
|---|---|---|---|---|---|---|
| Item | | 1 | 2 | 3 | Example 1 | Example 2 |
| A | | 700 | 700 | 700 | 700 | 700 |
| B | | 650 | 650 | 650 | 650 | 650 |
| C | | 599 | 629.5 | 647.1 | 600 | 645 |
| D | | 1.0 | 0.5 | 2.9 | 0 | 5.0 |
| E | | 50 | 20 | 0 | 50 | 0 |
| Evaluation | Breaking | ◯ | ◯ | ◯ | ◯ | ◯ |
| | Damage | ◯ | ◯ | ◯ | X | X |

Note:
Unit of figures for items A to E is mm.

### Example 4

Negative Electrode

Difference Between Front and Rear: D=1 mm

Coating of Negative Active Material Coating Composition

One surface of a copper foil having thickness of 10 μm was subjected to coating and drying process, and the other surface thereof was consecutively subjected to coating and drying process using the following negative electrode active material coating composition by means of the unwinder, the winder and an in-line double-face coating device equipped with two pairs of a die head and a dryer shown in FIG. 3. The coating amount per one surface was 110 g/m² after dried.

Except that the electrode plate was pressed after coating by means of a roll press machine so that the density of the negative electrode active material layer was to be 1.6 g/cm³, a negative electrode plate was obtained in the same manner as Example 1.

The negative electrode active material coating composition was prepared in a manner of mixing and kneading 93 parts by weight of MCMB-6-28 (trade name for negative electrode active material available from Osaka Gas Chemicals Co., Ltd.), and 58.3 parts by weight (it is equivalent to 7 parts by weight in solid content) of KFL #1120 (trade name for 12% polyvinyliden fluoride in N-methylpyrrolidone solution available from Kureha Chemical Industry Co., Ltd.) by means of a planetary mixer, adding N-methylpyrrolidone for adjusting viscosity, and then dispersing it.

### Examples 5-6 and Comparative Examples 3-4

Negative Electrode

Difference “D” Between Front and Rear: Changing

Except that the positional relationship for coating was set as values shown in Table 2, a negative electrode plate was obtained in the same manner as Example 4.

TABLE 2
(positive electrode plate)

| | | Example | Example | Example | Comparative | Comparative |
|---|---|---|---|---|---|---|
| Item | | 4 | 5 | 6 | Example 3 | Example 4 |
| A | | 700 | 700 | 700 | 700 | 700 |
| B | | 650 | 650 | 650 | 650 | 650 |
| C | | 599 | 629.5 | 647.1 | 600 | 645 |
| D | | 1.0 | 0.5 | 2.9 | 0 | 5.0 |
| E | | 50 | 20 | 0 | 50 | 0 |
| Evaluation | Breaking | ◯ | ◯ | ◯ | X | ◯ |
| | Damage | ◯ | ◯ | ◯ | ◯ | X |

Note:
Unit of figures for items A to E is mm.

### Example 7

Battery

A separator 23 made of a polypropylene microporous film was laid between the positive electrode plate of Example 1 and the negative electrode plate of Example 4 each of which has been fixed to a terminal to pass electric current to obtain a layered product, and it was vorticosely wound up for several times to obtain a cylindrical electrode plate-couple. The lead terminal portions of the electrode plate-couple were connected to inside of bottom of a battery case and to inside of top of the battery sealing plate respectively by spot welding.

As the battery case, a cylindrical case made of stainless was used. As a nonaqueous solvent, a solution of ethylene carbonate: dimethylcarbonate=1:1 (mass ratio) was used, and LiPF₆ was solved at 1 mol/1 L therein to make a solution of electrolyte in organic solvent (nonaqueous electrolyte). The solution of electrolyte in organic solvent was poured into the battery case containing the electrodes. The battery case and the sealing plate were caulked and sealed with a packing made of polypropylene disposed between them, thus obtaining a cylindrical lithium ion secondary battery of Example 7.

### Examples 8-9

Battery

Except that a combination of the positive electrode plate of Example 2 and the negative electrode plate of Example 5, and a combination of the positive electrode plate of Example 3 and the negative electrode plate of Example 6 were used respectively, batteries of Examples 8 and 9 were obtained in the same manner as Example 7. All batteries of Examples 7 to 9 functioned properly. Further, the battery capacity was in the range of standard, and the capacity did not decline.

Evaluation

The damage in electrode active material layers and the breaking of collectors in the pressing step of the production process were evaluated. The damage in electrode active material layers was evaluated by visually observing the electrode active material layers, and a case of “pass” was expressed by the marking “∘” if significant chipping or cracking was not observed, and a case of “failure” was expressed by “X” if chipping or cracking was observed. The breaking of collectors was evaluated based on the occurrence number of breaking per 1000 m of wound sheet in pressing process, and a case of “pass” was expressed by the marking “∘” if the number of breaking was one or less, and a case of “failure” was expressed by “X” if the number was two or more.

As shown in Tables 1 and 2, all of Examples 1 to 6 passed.

In Comparative example 3, breaking occurred frequently and it was not able to press. In Comparative examples 1, 2 and 4, cracking and chipping were observed in coated layers at the edge of starting sides.

1. An electrode plate for a battery, comprising a collector in a sheet-like form, a first electrode active material layer intermittently formed on one surface of the collector, and a second electrode active material layer intermittently formed on the other surface of the collector so as to have a positional relationship in which a starting side of the coated section of the second electrode active material layer is 0.5 to 2.9 mm off from a starting side of the coated section of the first electrode active material layer and shifted to a finishing side thereof.

2. A production process for an electrode plate for a battery comprising steps of:
a) providing a collector in a sheet-like form;
b) providing an electrode active material layer coating composition;
c) forming a first electrode active material layer by applying an electrode active material layer coating composition intermittently to one surface of the collector by means of a coating means which is capable of consecutively subjecting one surface and the other surface of the collector to intermittent coating process;
d) consecutively after the step “c”, forming a second electrode active material layer by applying the electrode active material layer coating composition intermittently to the other surface of the collector by means of the coating means described above, wherein a running direction of the coating process for the other surface is directed toward the same direction as the coating process for one surface of the collector, and wherein a starting position of the coating section is set so as to have a positional relationship in which it is 0.5 to 2.9 mm off from a starting side of the coated section of the first electrode active material layer and shifted to a finishing side thereof; and
e) pressing the collector in which electrode active material layers are formed on both sides.

3. A nonaqueous electrolyte battery wherein an electrode plate-couple in which the positive electrode plate which is formed with a positive electrode active material layer having arrangement of an electrode plate for a battery according to claim 1 and the negative electrode plate which is formed with a negative electrode active material layer having arrangement of an electrode plate for a battery according to claim 1 are wound up together with a separator disposed between the electrode plates, and a solution of electrolyte in organic solvent are sealed in a container having a sealed opening capable of, before sealing, inserting the electrode plate-couple and the solution of electrolyte therethrough.

4. A production process for a nonaqueous electrolyte battery comprising steps of:
inserting the electrode plate-couple, in which a positive electrode plate which is formed with a positive electrode active material layer having arrangement of an electrode plate for a battery produced by a method according to claim 2 and a negative electrode plate which is formed with a negative electrode active material layer having arrangement of an electrode plate for a battery produced by a method according to claim 2 is wound up together with a separator disposed between the electrode plates, and a solution of electrolyte in organic solvent into a container through its opening; and
sealing the opening to form a sealed opening.
